(19) United States
(12) Patent Application Publication
(10) Pub. No.: US 2024/0067538 A1
(43) Pub. Date: Feb. 29, 2024

(54) Enhanced Water Cleaning Net Device

(71) Applicant: Rebecca Fassett, Pittsfield, PA (US)

(72) Inventor: Rebecca Fassett, Pittsfield, PA (US)

(21) Appl. No.: 17/894,701

(22) Filed: Aug. 24, 2022

(51) Int. Cl. C02F 1/40; B01D 29/05; C02F 1/00; E04H 4/16

(52) U.S. Cl. CPC C02F 1/40; B01D 29/05; C02F 1/001; E04H 4/1609; B01D 2201/4092

(57) ABSTRACT

An enhanced water cleaning net device for removing debris and algae from a body of water includes a frame having a rectangular shape. The frame is a metal material having a pair of lateral beams, a tip beam, a base beam, and a center cutout. Furthermore, the frame has a pair of mounting holes. A net is positioned within the center cutout and has a mesh pattern. A plurality of fasteners retains the net within a fixed position relative to the frame. A rod is secured to the frame by a pair of mounting fasteners nested within a pair of apertures of the rod and the pair of mounting holes of the frame. In addition, a pole is coupled to the rod and has a telescopic handle for adjusting a length of the frame relative to the pole.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (g) BACKGROUND OF THE INVENTION

### (1) FIELD OF THE INVENTION

The disclosure relates to water skimmer device and more particularly pertains to a new water skimmer device for removing debris and algae from a body of water.

### (2) DESCRIPTION OF RELATED ART INCLUDING INFORMATION DISCLOSED UNDER 37 CFR 1.97 AND 1.98

The prior art relates to water skimmer devices. The prior art includes a variety of water skimmer devices including a net for removing debris from a body of water. Known prior art lacks a water skimmer device comprising a frame and net being a metal material configured for being able to support a range of weight without fracturing and being able to remove debris and algae from a body of water.

### (H) BRIEF SUMMARY OF THE INVENTION

An embodiment of the disclosure meets the needs presented above by generally comprising a frame having a rectangular shape. The frame is a metal material having a pair of lateral beams, a tip beam, and a base beam. Additionally, the frame has a center cutout. Each of the lateral beams has a pair of protrusions and each of the protrusions has a hole. Furthermore, the frame has a pair of mounting holes. A net is positioned within the center cutout of the frame. The net has a mesh pattern and includes a pair of side edges positioned adjacent to a respective one of the pair of lateral beams off the frame. A plurality of fasteners is nested within the hole of each of the protrusions of each of the lateral beams and the net and is configured for retaining the net within a fixed position relative to the frame. A rod is configured for securing to the frame. The rod has a pair of apertures wherein a pair of mounting fasteners is nested within the pair of apertures and the pair of mounting holes. In addition, a pole is coupled to the rod. The pole has a telescopic handle being configured for adjusting a length of the frame relative to the pole.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom isometric view of an enhanced water cleaning net device according to an embodiment of the disclosure.

FIG. 2 is a top view of an embodiment of the disclosure.

FIG. 3 is a side view of an embodiment of the disclosure.

FIG. 4 is a top isometric view of an embodiment of the disclosure.

FIG. 5 is a top view of an embodiment of the disclosure.

FIG. 6 is an in-use view of an embodiment of the disclosure.

### (J) DETAILED DESCRIPTION OF THE INVENTION

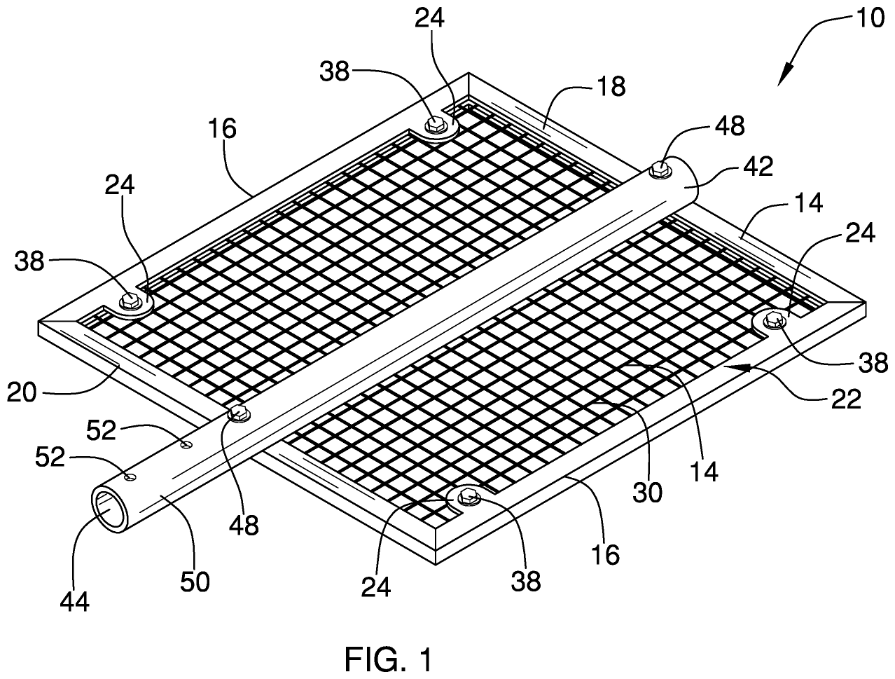

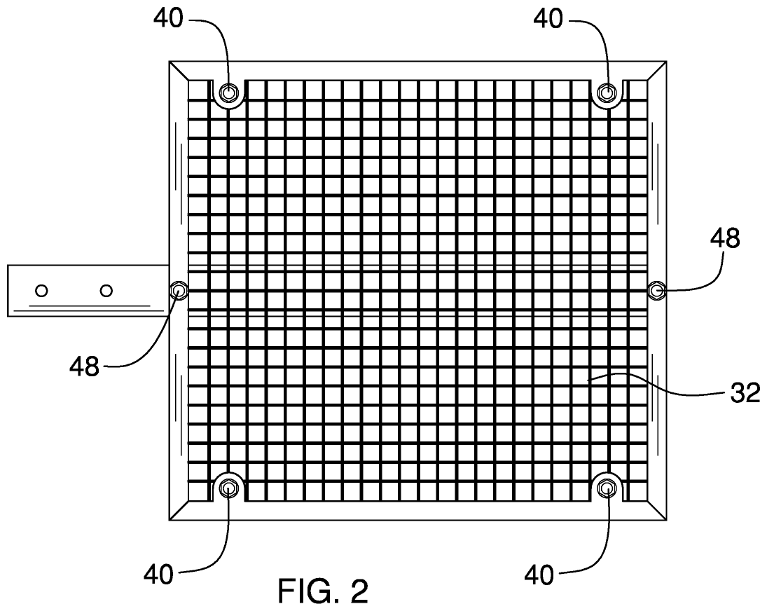

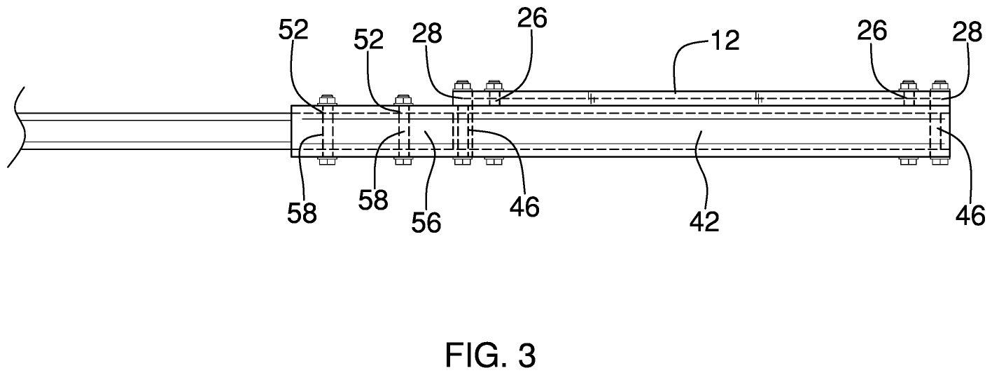

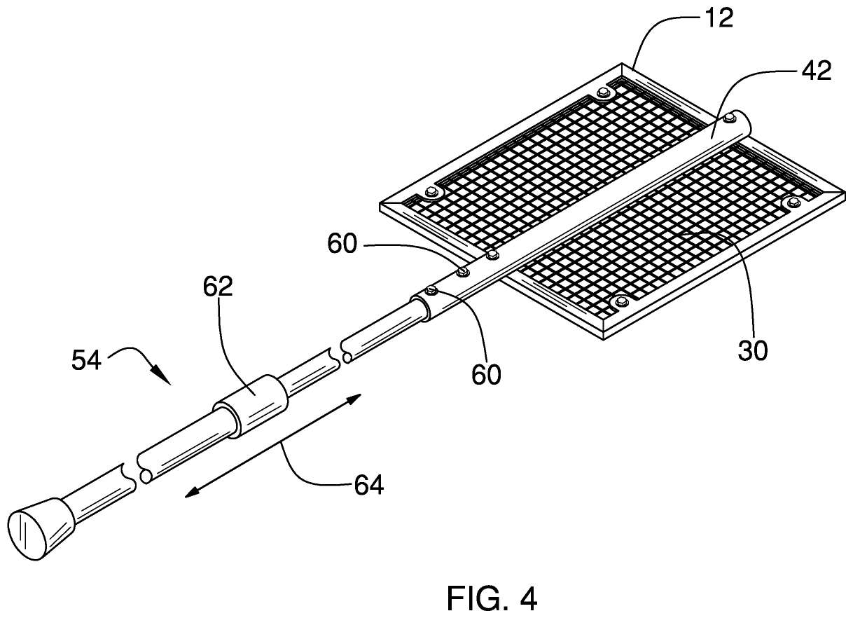

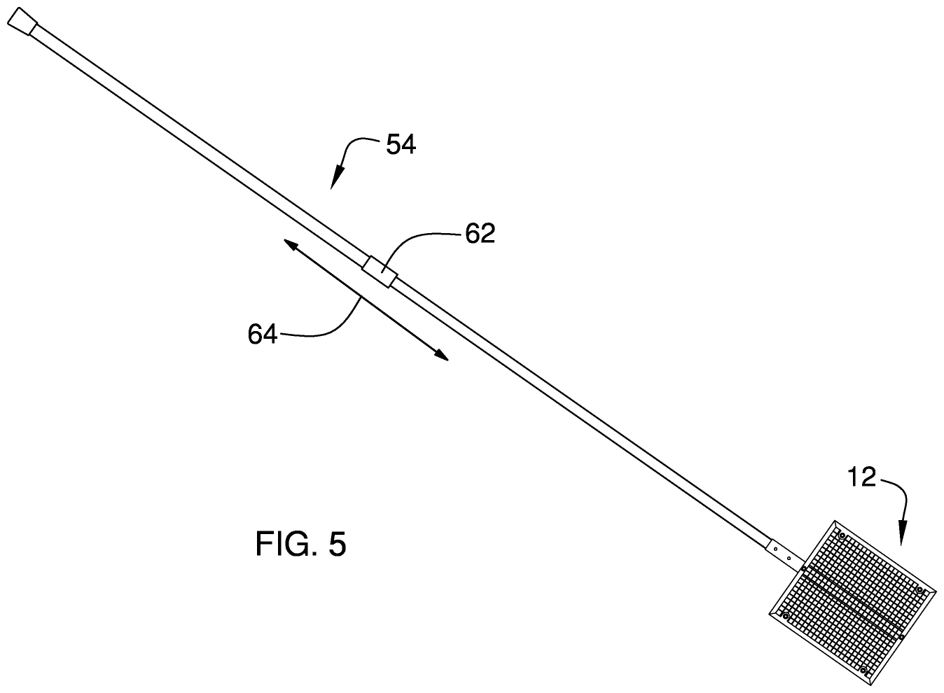

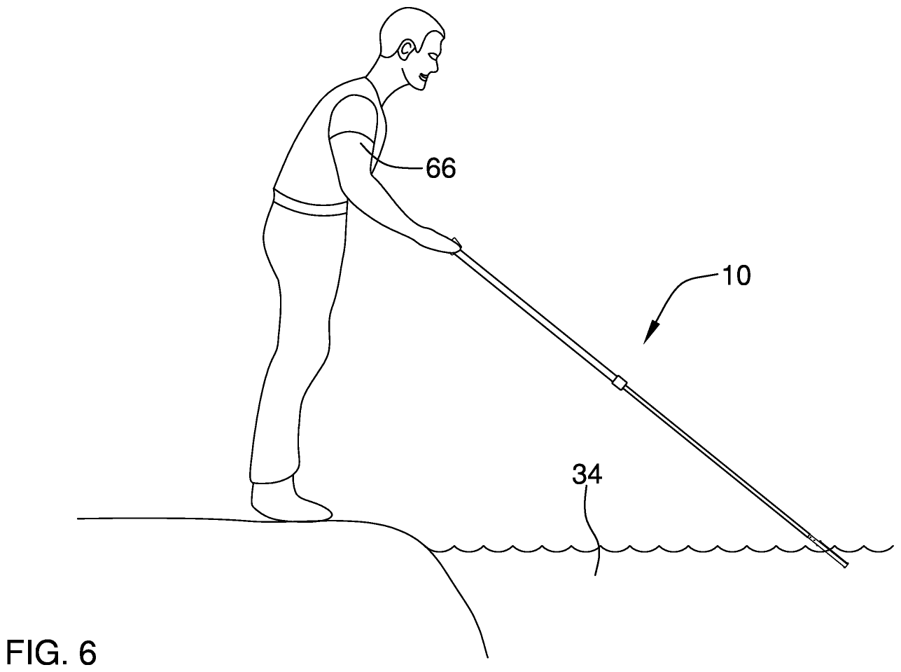

With reference now to the drawings, and in particular to FIGS. 1 through 6 thereof, a new water skimmer device embodying the principles and concepts of an embodiment of the disclosure and generally designated by the reference numeral 10 will be described.

As best illustrated in FIGS. 1 through 6, the enhanced water cleaning net device generally comprises a frame 12. The frame 12 has a rectangular shape and is a metal material 14 configured for retaining a range of weight without fracturing. The frame 12 has a pair of lateral beams 16, a tip beam 18, and a base beam 20. The pair of lateral beams 16 is positioned perpendicular relative to the tip beam 18 and the base beam 20. In addition, each of the lateral beams 16 is elongated greater than the tip beam 18 and the base beam 20. The frame 12 has a center cutout 22 defining a space allowing water to flow through the frame. Furthermore, each of the lateral beams 16 has a pair of protrusions 24 being a semi-oval shape and positioned facing the center cutout 22 of the frame 12. Each of the protrusions 24 has a hole 26 configured for nesting a bolt. Additionally, the frame 12 has a pair of mounting holes 28 being positioned on a respective one of the tip beam 18 and the base beam 20. The pair of mounting holes 28 is positioned in a center between each of the lateral beams 16.

A net 30 is positioned within the center cutout 22 of the frame 12. The net 30 has a mesh pattern 32 being configured for including a plurality of wires positioned in a perpendicular pattern to define a plurality of squares. The plurality of squares allow for a fluid to flow through the net and retaining a solid within the net 30 when in-use. The net is has depth of twenty five millimeters and is the metal material 14 wherein the net 30 is configured for supporting a range of weight of debris and algae within a body of water 34 without fracturing. The net 30 has a pair of side edges 36 being positioned adjacent to a respective one of the pair of lateral beams 16 of the frame 12. The pair of side edges 36 is positioned upon each of the protrusions 24 of the pair of lateral beams 16 of the frame 12.

A plurality of fasteners 38 is nested within a respective one of the hole 26 of each of the protrusions 24 of each of the lateral beams 16 and the net 30. Each of the fasteners 38 includes a bolt and nut being a stainless steel material 40. The stainless steel material is configured for having a high strength relative to other metals and having capabilities to withstand a range of weight without fracturing. The plurality of fasteners 38 is configured for retaining the net 30 within a fixed position relative to the frame 12.

A rod 42 is configured for securing to the frame 12 and reinforcing the net 30 of the frame 12 when in-use. The rod 42 is a tubular shape having a hollow interior 44. The rod 42 has a pair of apertures 46 being circular and positioned upon the pair of mounting holes 28 of the frame 12. A pair of mounting fasteners 48 is nested within the pair of apertures 46 and the pair of mounting holes 28 and retains the rod 42 in a fixed position relative to the frame 12. Each of the mounting fasteners 48 is the bolt and nut like the pair of fasteners 38 of the frame 12. An end 50 of the rod 42 is positioned proximate to the base beam 20 of the frame 12 and has a pair of slots 52.

A pole 54 is coupled to the rod 42 by an insert 56 nested within the hollow interior 44 of the end 50 of the rod 42. The insert 56 of the pole 54 has a pair of openings 58 being complementary to the pair of slots 52 of the end 50 of the rod 42. A pair of pole fasteners 60 is nested within the pair of slots 52 and the pair of openings 58 and retains the pole 54 in a fixed positioned relative to the rod 42. Additionally, the pole 54 has a telescopic handle 62 being configured for adjusting a length 64 of the frame 12 relative to the pole 54. The pole 54 is configured for being held by the user 66 when removing debris and algae from the body of water 34.

In use, the user 66 inserts the frame 12 within the body of water 34 to remove debris and algae from the water of the body of water 34. The net 30 and the frame 12 are configured for retaining a range of weight without fracturing wherein reducing the possibility of damaging the frame 12 or the net 30. The frame 12 can be removed from the pole 54 by removing the pair of pole fasteners 60 from the end 50 of the rod 42 wherein the user 66 can use only the frame 12 without the pole 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An enhanced water net device configured for removing debris and algae from a body of water, the enhanced water net device comprising:
a frame having a rectangular shape, said frame being a metal material, said frame having a pair of lateral beams, said frame having a tip beam and a base beam, said frame having a center cutout, each of said lateral beams having a pair of protrusions, each of said protrusions having a hole, said frame having a pair of mounting holes;
a net being positioned within said center cutout of said frame, said net having a mesh pattern, said net having a pair of side edges, each of said side edges being positioned adjacent to a respective one of said pair of lateral beams off said frame;
a plurality of fasteners being nested within said hole of each of said protrusions of each of said lateral beams and said net, said plurality of fasteners being configured for retaining said net within a fixed position relative to said frame;
a rod being configured for securing to said frame, said rod having a pair of apertures, a pair of mounting fasteners being nested within said pair of apertures and said pair of mounting holes; and
a pole being coupled to said rod, said pole having a telescopic handle, said telescopic handle being configured for adjusting a length of said frame relative to said pole.

2. The enhanced water net device of claim 1, further comprising said metal material being configured for retaining a range of weight without fracturing.

3. The enhanced water net device of claim 2, further comprising said pair of lateral beams being positioned perpendicular relative to said tip beam and said base beam, each of said lateral beams being elongated greater than said tip beam and said base beam.

4. The enhanced water net device of claim 1, further comprising said center cutout defining a space allowing water to flow through said frame.

5. The enhanced water net device of claim 1, further comprising each of said protrusions being a semi-oval shape, said pair of protrusions of each of said lateral beams being positioned facing said center cutout of said frame.

6. The enhanced water net device of claim 5, further comprising said hole of each of said protrusions being configured for nesting a bolt.

7. The enhanced water net device of claim 3, further comprising said pair of mounting holes being positioned on a respective one of said tip beam and said base beam, said pair of mounting holes being positioned in a center between each of said lateral beams.

8. The enhanced water net device of claim 1, further comprising said mesh pattern being configured for including a plurality of wires positioned in a perpendicular pattern to define a plurality of squares.

9. The enhanced water net device of claim 8, further comprising said net being having depth of twenty five millimeters.

10. The enhanced water net device of claim 1, further comprising said net being said metal material.

11. The enhanced water net device of claim 1, further each of said fasteners including a bolt and nut.

12. The enhanced water net device of claim 11, further comprising each of said fasteners being a stainless steel material.

13. The enhanced water net device of claim 12, further comprising said rod being a tubular shape having a hollow interior.

14. The enhanced water net device of claim 1, further comprising each of said apertures being circular, said pair of apertures being positioned upon said pair of mounting holes of said frame.

15. The enhanced water net device of claim 12, further comprising each of said mounting fasteners being said bolt and nut.

16. The enhanced water net device of claim 15, further comprising said pair of mounting fasteners retaining said rod in a fixed position relative to said frame.

17. The enhanced water net device of claim 13, further comprising an end of said rod having a pair of slots, said end of said rod being positioned proximate to said base beam of said frame.

18. The enhanced water net device of claim 17, further comprising said pole having an insert, said insert of said pole being nested within said hollow interior of said end of said rod, said insert of said having a pair of openings being complementary to said pair of slots of said end of said rod.

19. The enhanced water net device of claim 18, further comprising a pair of pole fasteners being nested within said pair of slots and said pair of openings, said pair of pole fasteners retaining said pole in a fixed positioned relative to said rod.

20. An enhanced water net device configured for removing debris and algae from a body of water, the enhanced water net device comprising:
a frame having a rectangular shape, said frame being a metal material, said metal material being configured for retaining a range of weight without fracturing, said frame having a pair of lateral beams, said frame having a tip beam and a base beam, said pair of lateral beams being positioned perpendicular relative to said tip beam and said base beam, each of said lateral beams being elongated greater than said tip beam and said base beam, said frame having a center cutout, said center cutout defining a space allowing water to flow through said frame, each of said lateral beams having a pair of protrusions, each of said protrusions being a semi-oval shape, said pair of protrusions of each of said lateral beams being positioned facing said center cutout of said frame, each of said protrusions having a hole, said hole being configured for nesting a bolt, said frame having a pair of mounting holes, said pair of mounting holes being positioned on a respective one of said tip beam and said base beam, said pair of mounting holes being positioned in a center between each of said lateral beams;
a net being positioned within said center cutout of said frame, said net having a mesh pattern, said mesh pattern being configured for including a plurality of wires positioned in a perpendicular pattern to define a plurality of squares, said net being having depth of twenty five millimeters, said net being said metal material, said net having a pair of side edges, each of said side edges being positioned adjacent to a respective one of said pair of lateral beams off said frame;
a plurality of fasteners being nested within said hole of each of said protrusions of each of said lateral beams and said net, each of said fasteners including a bolt and nut, each of said fasteners being a stainless steel material, said plurality of fasteners being configured for retaining said net within a fixed position relative to said frame;
a rod being configured for securing to said frame, said rod being a tubular shape having a hollow interior, said rod having a pair of apertures, each of said apertures being circular, said pair of apertures being positioned upon said pair of mounting holes of said frame, a pair of mounting fasteners being nested within said pair of apertures and said pair of mounting holes, each of said mounting fasteners being said bolt and nut, said pair of mounting fasteners retaining said rod in a fixed position relative to said frame, an end of said rod having a pair of slots, said end of said rod being positioned proximate to said base beam of said frame; and
a pole being coupled to said rod, said pole having an insert, said insert of said pole being nested within said hollow interior of said end of said rod, said insert of said having a pair of openings being complementary to said pair of slots of said end of said rod, a pair of pole fasteners being nested within said pair of slots and said pair of openings, said pair of pole fasteners retaining said pole in a fixed positioned relative to said rod, said pole having a telescopic handle, said telescopic handle being configured for adjusting a length of said frame relative to said pole.
